(19) United States
(12) Patent Application Publication
(10) Pub. No.: US 2010/0070925 A1
(43) Pub. Date: Mar. 18, 2010

(54) SYSTEMS AND METHODS FOR SELECTING MEDIA CONTENT OBTAINED FROM MULTPLE SOURCES

(75) Inventors: Andrew E. Einaudi, San Francisco, CA (US); Robert Bruce Brown, San Francisco, CA (US)

Correspondence Address: INGRASSIA FISHER & LORENZ, P.C. (EchoStar), 7010 E. COCHISE ROAD, SCOTTSDALE, AZ, 85253, US

(73) Assignee: SLING MEDIA INC., Foster City, CA (US)

(21) Appl. No.: 12/543,278

(22) Filed: Aug. 18, 2009

Related U.S. Application Data
(60) Provisional application No. 61/095,306, filed on Sep. 8, 2008.
(60) Provisional application No. 61/141,915, filed on Dec. 31, 2008.

(51) Int. Cl. G06F 3/048; G06F 17/30

(52) U.S. Cl. 715/830; 715/841; 707/E17.014

(57) ABSTRACT

Methods, systems and devices present information on a display in response to a user input received from an input device. One or more options are presented in a first portion of a user interface on the display, and a first user input indicating one of the options is received. In response to the first user input, a sub-menu of options associated with the indicated one of the first list of options is presented in a second portion of the user interface. In response to a second user input selecting the indicated one of the options, the sub-menu of options is presented in the first portion of the user interface. The various methods, systems and devices may be implemented in a media catcher system that selects and presents media content from one or more different sources.

### PRIORITY CLAIM

This application claims priority to U.S. Provisional Application Ser. No. 61/095,306 entitled SYSTEMS AND METHODS FOR PRESENTING MEDIA CONTENT OBTAINED FROM MULTIPLE SOURCES and filed on Sep. 8, 2008, which is incorporated herein by reference in its entirety.

This application also claims priority to U.S. Provisional Application Ser. No. 61/141,915 entitled SYSTEMS AND METHODS FOR SELECTING MEDIA CONTENT OBTAINED FROM MULTIPLE SOURCES and filed on Dec. 31, 2008, which is incorporated herein by reference in its entirety.

### TECHNICAL FIELD

The present disclosure generally relates to selection of media content for presentation on a television or other display.

### BACKGROUND

In the past, consumers generally viewed television programming as it was received live from a broadcast, cable or satellite source. As analog and digital recording devices (e.g., video cassette recorders, as well as digital/personal video recorders) became more prevalent, consumers were increasingly able to shift their television viewing to more convenient viewing times. Even more recently, the ability to “place shift” television viewing from one location to another has become more widespread. Using the various SLINGBOX products available from Sling Media of Foster City, Calif., for example, consumers are able remotely view television programming or other video signals that are provided by a receiver, media player, recorder or other media source that is physically located at a different place than the viewer. Traditionally, content has been placeshifted primarily from a receiver or recorder over a digital network to a personal computer, wireless phone or other portable device. Viewing placeshifted content at a remotely-located television, however, has been difficult in the past because most televisions do not have network connectivity or other mechanisms for communicating with remotely-located media sources.

In addition, consumers are showing increased interest in non-traditional sources of content. Streaming video received via the Internet or another network, for example, is becoming very commonplace; such content is typically enjoyed on a computer display, however, rather than on a television set. Moreover, many consumers now have video cameras or other equipment for generating their own content. Much of this content is in digital format that is most readily viewed on a personal computer or other digital computing device.

As a result, it is desirable to create systems, methods and/or devices that are able to select media content that is available from various sources for presentation on a conventional television or similar display. In particular, it is desirable to create interfaces for selecting and presenting content available from multiple sources. These and other desirable features and characteristics will become apparent from the subsequent detailed description and the appended claims, taken in conjunction with the accompanying drawings and this background section.

### BRIEF SUMMARY

According to various exemplary embodiments, methods, systems and devices present information on a display in response to a user input received from an input device. One or more options are presented in a first portion of a user interface on the display, and a first user input indicating one of the options is received. In response to the first user input, a sub-menu of options associated with the indicated one of the first list of options is presented in a second portion of the user interface. In response to a second user input selecting the indicated one of the options, the sub-menu of options is presented in the first portion of the user interface. The various methods, systems and devices may be implemented in a media catcher system that selects and presents media content from one or more sources.

In other embodiments, a system for presenting imagery on a display in response to user inputs received from an input device is presented. An exemplary system comprises a first interface configured to receive the user inputs from the input device, a second interface to the display, and a processor. The processor is coupled to each of the first and second interfaces and is configured to generate user interface imagery on the external display via the display interface, wherein the interface comprises a first column configured to present a plurality of options and a second column configured to automatically present one of a plurality of sub-menus associated with an identified one of the plurality of options presented in the first column, and wherein the processor is further configured to present the sub-menu associated with the identified one of the plurality of options in the first column in response to a user selection of the identified one of the plurality of options.

In still other embodiments, an exemplary device for providing media content from a storage device for presentation on a display comprises a first interface to a wireless input device, a second interface to the storage device, a third interface to the display, and a processor. The processor is configured to select media content from the storage device based upon user inputs received from the first interface in response to user interface imagery presented on the display via the third interface. The user interface imagery comprises a first column configured to present a plurality of options and a second column configured to automatically present one of a plurality of sub-menus associated with an identified one of the plurality of options presented in the first column. The processor is further configured to present the sub-menu associated with the identified one of the plurality of options in the first column in response to a user selection of the identified one of the plurality of options.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary media catcher system;

FIG. 2 is a block diagram of an exemplary media catcher device;

FIG. 3 is a data flow diagram showing an exemplary placeshifting application involving an exemplary media catcher device;

FIGS. 4-8 are displays of exemplary user interface images; and

FIG. 9 is a flowchart of an exemplary process for implementing an exemplary interface.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various embodiments provide a systems, methods and/or devices that incorporate a user interface that allows for convenient identification, searching, selection and/or other traversal of a file or other tree structure. The user interface may include, for example, a first portion that receives scrolling or other directional inputs related to a first level of a menu tree, and a second portion that automatically displays items from a second level of the tree. In a conventional tree structure that incorporates files and folders, for example, the first portion may list the contents of a first folder and allow browsing or scrolling between the contents of that folder. When one of the content items is identified (e.g., with a cursor or other identifier), the second portion of the interface may list the contents of that content item (e.g., the contents of a folder). This displaying of information within the second area of the interface may take place automatically, without the need to expressly select the menu item. In such embodiments, the user is able to “peek” into the sub-menus of the tree without expressly selecting each item in the primary list. This feature can provide very rapid searching of menu trees that incorporate a large number of files or other items.

According to some embodiments, the interface is used in conjunction with a media catcher device that allows the customer/user to connect multiple media experiences on a common television or other display. The catcher device may be able to receive a network media stream from a remotely-located placeshifting device, for example, as well as media streams from any sort of personal computer, web server and/or other network source. In various further embodiments, the media catcher device is also able to process content that is stored locally on a hard disk, flash drive or other digital storage device. The media catcher device therefore allows the user to access audio/visual content from multiple sources, including sources that are remotely located, on a common television or other display.

The media catcher device could therefore be used in any number of settings. It could be used, for example, to view content that is physically stored in another room, at a remotely-located home or office, or indeed anywhere that network access can be provided. A person could view programming from a digital video recorder located at home, for example, on a television located at another home, or at work, or at any other location. In other implementations, a person could use the media catcher device to view programming that is stored or hosted from any number of other devices, servers or other components.

In media catcher embodiments, the dual-area user interface can be particularly useful, because it can provide convenient access to files stored in multiple locations. A two-area interface can be used to quickly look at files stored on a disk drive or other moveable media, for example, or to look at files stored on a remotely-located placeshifting device or file server. Moreover, by creating a top-level menu that includes references to all of the different sources available to the media catcher device (e.g., placeshifting devices, computer servers, local media, etc.), the files available from a multitude of disjoint sources can be incorporated, accessed and/or searched as part of a common file system from within the media player device. This provides a significant level of convenience to the user that would not be otherwise available. Moreover, the “lookahead” features provided by the dual-area interface provide significant benefit in a media catcher device, which may commonly incorporate a relatively “flat” and “wide” file system (e.g., in the sense that a relatively large number of files may be contained within a relatively low number of hierarchical levels).

Although the two-area interface is commonly described herein with reference to a media catcher system, however, it should be noted that the invention is not so limited. Indeed, the dual-column or other two-area interface features described herein may be incorporated into any sort of device or system, including any sort of media player, file manager, computer system, consumer electronics device, set top box, television or other media receiver, and/or the like.

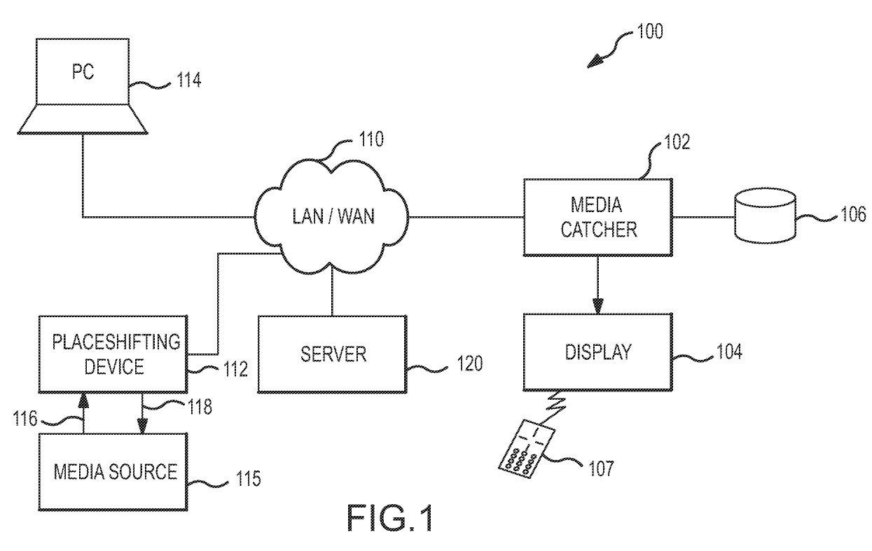

Turning now to the drawing figures and with initial reference to FIG. 1, an exemplary placeshifting system 100 suitably includes a media catcher device 102 that communicates with a placeshifting device 112, a personal computer 114, and/or any number of content servers 120 via network 110. Additionally, media catcher 102 may receive content from a locally-connected storage device 106, as appropriate. Media content received from any of the various sources is suitably processed at media catcher 102 to create the desired user experience and presented for display on display 104.

Media catcher device 102 is any device or component capable of receiving content from various sources and of processing the received content as appropriate to produce a desired experience for the user. Generally speaking, media catcher 102 is responsive to user commands received via a remote control 107 or other input device to obtain desired content from any number of content sources, and to format the obtained content for display to the user.

Many different media-shifting scenarios could be formulated based upon available computing and communications resources. In various embodiments, consumers may wish to placeshift content within a home, office or other structure, such as from a placeshifting device 112 to media catcher 102 located in another room. In such embodiments, the content stream will typically be provided over a wired and/or wireless local area network operating within the structure. In other embodiments, consumers may wish to placeshift content over a broadband or similar network connection from a primary location to a media catcher device 102 located in a second home, office, hotel or other remote location.

To that end, network 110 is any digital or other communications network capable of transmitting messages between senders and receivers. In various embodiments, network 110 may represent a wide area network, a local area network, and/or any combination of wide and local area networks. In embodiments wherein media catcher 102 is located at a different building or other remote location from a desired content source, for example, network 110 can include any number of public or private data connections, links or networks supporting any number of communications protocols. Network 110 may include the Internet, for example, or any other network based upon TCP/IP or other conventional protocols. In many embodiments, system 100 is wholly or largely implemented within a relatively small geographical area (e.g., within a home or other structure). In such embodiments, network 110 may represent a conventional local area network, such as one or more IEEE 802.3 and/or IEEE 802.11 networks. Network 110 as shown in FIG. 1, then, is intended to broadly encompass any digital communications network(s), systems or architectures for transmitting data between the various components of system 100.

As noted above, media catcher device 102 is able to receive media content from any number of content sources via network 110. In various embodiments, media catcher 102 receives a media stream from one or more placeshifting devices 112. Placeshifting device 112 suitably packetizes media content 116 received from a media source 115 for transmission over communications network 110. To that end, placeshifting device 112 is any component, hardware, software logic and/or the like capable of transmitting a packetized stream of media content over network 110. Although FIG. 1 shows only a single placeshifting device 112, in practice system 100 may include any number of placeshifting devices 112 and/or media sources 115, each of which may be able to stream media content to media catcher 102.

In various embodiments, each placeshifting device 112 incorporates suitable transcoder logic to convert audio/video or other media data 116 into a packetized format (e.g., MPEG, QuickTime, Windows Media and/or the like) that can be transmitted over network 110. The media data 116 may be in any format, and may be received from any source 115 such as any digital or analog recording device (e.g., a digital video recorder); any broadcast, cable or satellite television programming source; any “video-on-demand” or similar source; a player for any sort of digital video disk (DVD) or other removable media; a security or other video camera; and/or the like. Placeshifting device 112 may also provide control instructions to one or more media sources 115 using any sort of infrared, radio frequency, or other signals 118. Such signals 118 may be provided, for example, from an “IR Blaster” or similar feature that emulates infrared or other RF instructions provided from a remote control associated with the media source 115. U.S. Patent Publication No. 2006/0095471 describes one example of a placeshifting encoder, although the concepts described herein could be used in conjunction with products and services available from any source, including those available from Sling Media of Foster City, Calif. and others.

Media catcher 102 is also able to receive content from other sources via network 110. In various embodiments, computer 114 executes software that is able to provide a video stream to media catcher 102 over network 110. The video stream may be, for example, a Windows Media, Quicktime and/or MPEG stream, although other formats could be equivalently used. In various embodiments, computer 114 executes a software program that encodes and transmits a portion of a screen display viewable on a monitor associated with computer 114. Such embodiments may, for example, encode a portion of a screen display bitmap into a streaming format that can be transmitted on the media. In such embodiments, a media file or clip that would ordinarily be viewed on the computer display can be simultaneously (or alternately) transmitted to media catcher 102 for presentation on display 104. In other embodiments, computer 114 transmits media data in any sort of streaming, file-based, batch or other format to media catcher 102 for display as desired, as described more fully below.

System 100 may also include any number of servers 120 that are each capable of providing media content to media catcher 102, or of at least directing media catcher 102 to media content, as appropriate. In various embodiments, server 120 is a conventional Internet server that interacts with a browser or viewer application executing on media catcher 102 to provide images, audio, video and/or other content as desired. In further embodiments, server 120 is a web server that includes links to other content servers available to the media catcher 102. In such embodiments, a user may direct the media catcher 102 to initially contact server 120, and subsequently direct media catcher 102 to follow hypertext markup language (HTML) or other links provided by server 120. Many different interface options are available across a wide array of equivalent implementations to allow media catcher to obtain media content from any number of servers 120.

In various embodiments, media catcher 102 additionally communicates with an external storage device 106, such as any sort of disk drive, flash memory drive, and/or the like. In such embodiments, users may store media files on storage device 106 for playback on display 104. Such files may include video files, still imagery, audio files and/or any other type of media from any source. A user may keep a collection of home videos, for example, on a hard drive or other storage medium 106 that can be connected to media catcher 102.

In operation, then, media catcher 102 is able to obtain media content from various sources, to process the received content for playback, and to provide suitable output signals 105 for presenting the media content on display 104. In one embodiment, media catcher 102 is able to receive encoded media streams from placeshifting device and computer 114, and is additionally able to receive streaming and/or file-based content from server 120 and local storage 106. This content can be received in any of various formats and can be decoded for presentation on display 104. In various embodiments, media catcher 102 provides video output signals 105 to display 104 in any compatible format. In embodiments wherein display 104 is a conventional television, for example, media catcher device 102 may provide video output signals 105 in any conventional format, such as component video, S-video, High-Definition Multimedia Interface (HDMI), Digital Visual Interface (DVI), IEEE 1394, and/or any other formats as desired. By designing media catcher 102 to support multiple formats and multiple sources of media content, the user is able to conveniently enjoy content from multiple sources on a common display 104.

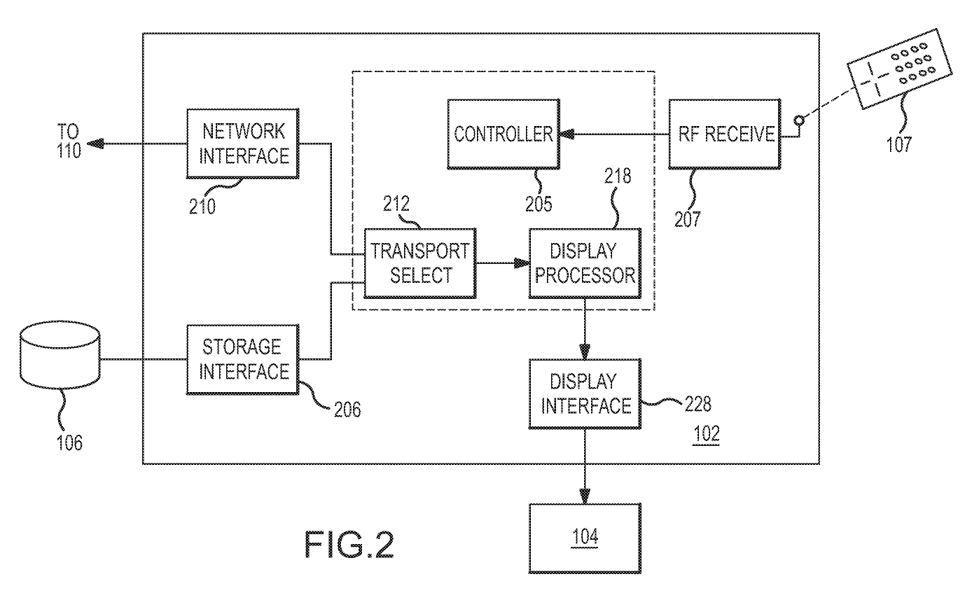

FIG. 2 provides additional detail about an exemplary media catcher device 102 that includes a network interface 210, a storage interface 206, and a display interface 228 as appropriate. FIG. 2 also shows a transport select module, display processor module and control module 205 executing on a common processor 207. Other embodiments may incorporate additional or alternate processing modules from those shown in FIG. 2, and/or may omit one or more modules shown in FIG. 2, and/or may organize the various modules in any other manner different from the exemplary arrangement shown in FIG. 2.

Media catcher device 102 may be logically and physically implemented in any manner. FIG. 2 shows various logical and functional features that may be present in an exemplary device 102; each module shown in the figure may be implemented with any sort of hardware, software, firmware and/or the like. Any of the various modules may be implemented with any sort of general or special purpose integrated circuitry, for example, such as any sort of microprocessor, microcontroller, digital signal processor, programmed array and/or the like. In various embodiments, any number of the modules shown in FIG. 2 may be implemented as part of a “system on a chip” (SoC) using any suitable processing circuitry under control of any appropriate control logic 205. In such embodiments, control logic 205 executes within an integrated SoC or other processor that also implements transport selector 212 and display processor 218, as well as any logic that controls network interface 210 and/or storage interface 206, as appropriate. NXP Semiconductors of Eindhoven, Netherlands, for example, produces several models of processors that are capable of supporting SoC implementations, although products from any number of other suppliers could be equivalently used. In still other embodiments, various distinct chips, circuits or components may be inter-connected with each other to implement the functions represented in FIG. 2.

Various embodiments of control logic 205 can include any circuitry, components, hardware, software and/or firmware logic capable of controlling the components and processes operating within device 102. Although FIG. 2 shows control logic 205 as a discrete feature, in practice control logic 205 will typically interact with each of the other modules and components operating within media catcher 102 to direct the operation thereof.

Media catcher 102 includes an appropriate network interface 210 that operates using any implementation of protocols or other features to support communication by device 102 on network 110. In various embodiments, network interface 210 supports conventional LAN, WAN or other protocols (e.g., the TCP/IP or UDP/IP suite of protocols widely used on the Internet) to allow device 102 to communicate on network 110 as desired. Network interface 210 typically interfaces with network lo using any sort of LAN adapter hardware, such as a conventional network interface card (NIC) or the like provided within device 102.

Storage interface 206 is any physical, logical and/or other features that can be used to interface with an external storage medium 106 such as a magnetic or optical disk drive, a flash memory card, and/or any other sort of storage as appropriate. In various embodiments, storage interface 206 is a universal serial bus (USB), IEEE 1394 (“Firewire”) or other standard interface that allows users to store files at a conventional computer system (e.g., computer 114 in some embodiments) for playback via media catcher 102. In such embodiments, media catcher 102 will typically include a physical interface that can receive the media 106, as well as a logical interface that may be implemented within the SoC or other logical features of device 102 to execute in response to control logic 205.

In many embodiments, media catcher 102 includes an input interface 207 that receives wireless infrared or other radio frequency (RF) instructions from remote control 107. Input interface 207 may also include any number of buttons, sliders, knobs or other physical input devices located on a housing of device 102. In operation, user instructions provided by remote control 107 and/or any other input features are received at input interface 207 for subsequent processing by control logic 205. In various embodiments, control logic 205 takes appropriate actions based upon the particular inputs received; examples of appropriate actions may include directing display processor 218 to generate or modify the presented imagery, directing a command packet to be sent to a remotely-located content source, and/or any other actions.

Transport stream select module 212 is any hardware and/or software logic capable of selecting a desired media stream from the available sources. In the embodiment shown in FIG. 2, transport select module 212 is able to select video signals for presentation on one or more output interfaces 228. Stream select module 212 therefore responds to viewer inputs (e.g., via control logic 205) to simply switch content received from a network source 210 or from storage 106 to one or more display processing modules 218.

Display processor module 218 includes any appropriate hardware, software and/or other logic to create desired screen displays at interface 228 as desired. In various embodiments, display processor module 218 is able to decode and/or transcode the received media to a format that can be presented at display interface 228. The generated displays, including received/stored content and any other displays may then be presented to one or more output interfaces 228 in any desired format. In various embodiments, display processor 218 produces an output signal encoded in any standard format (e.g., ITU656 format for standard definition television signals or any format for high definition television signals) that can be readily converted to standard and/or high definition television signals at interface 228.

Display processing module 218 is also able to produce on screen displays (OSDs) for electronic program guide, setup and control, input/output facilitation user interface imagery and/or other features that may vary from embodiment to embodiment. Such displays are not typically contained within the received or stored broadcast stream, but are nevertheless useful to users in interacting with device 102 or the like. In particular, on-screen displays can be used to generate user interface imagery that allows for convenient program selection, control and the like, as described more fully below.

In operation, then, the user selects desired media content from a network source (e.g., placeshifting device 112, computer 114, server 120 in FIG. 1), and provides appropriate inputs via remote control 107 or the like. The commands are received at input interface 207 and provided to control logic 205, as appropriate. Control logic 205 is then able to contact the appropriate content source via network interface 210, storage interface 206, and/or the like, and to select the desired content using, for example, transport select module 212. The obtained content can then be processed by display processor 218 and received at display interface 228 in an appropriate format so that output signals 105 can be compatible with the external display 104.

Additionally, in various embodiments, media catcher 102 is also able to transmit control information to a remotely-located media source via network 110. As user instructions are received from remote control 107, for example, control logic 205 or another feature within media catcher 102 may formulate a command request message that is transmitted over network 110 for executing at the remote media source 115 to change the media stream provided by that remote media source 115.

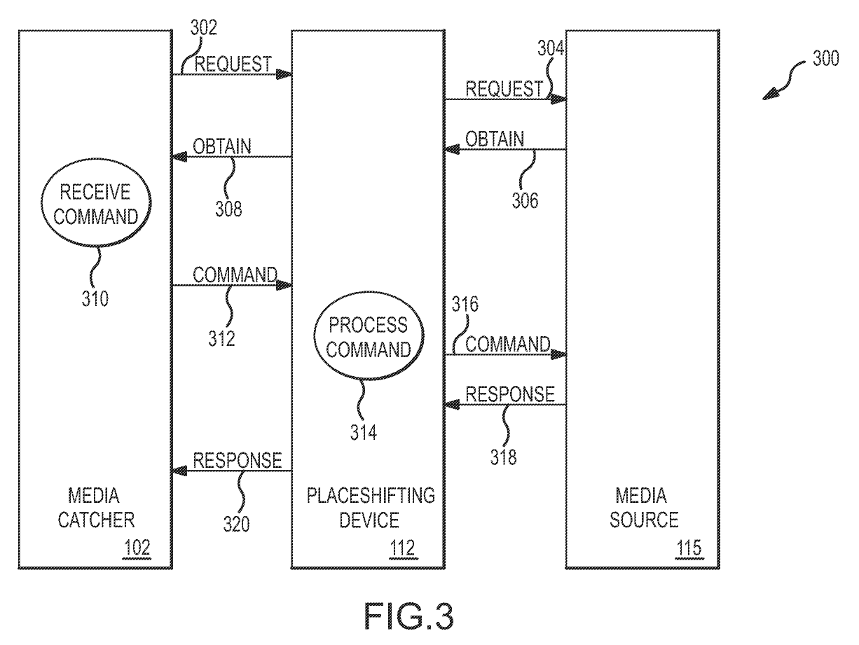

FIG. 3 shows an exemplary process 300 for transmitting command information received at a media catcher 102 for processing at a remote media source 115. FIG. 3 shows messages sent and received by each of the entities 102, 112, 115 involved in the process 300, as well as other actions that may be performed by one or more entities within system 100 (FIG. 1). In practice, the overall process 300 may be implemented with various methods executed by one or more entities 102, 112, 115, as described more fully below. Generally speaking, each of the method steps shown in FIG. 3 may be implemented in software or firmware that may be stored in memory, mass storage or any other storage medium available to the executing device, and that may be executed on any processor or control circuitry associated with the executing device.

With primary reference to FIG. 3, when a user requests viewing of a video stream from a remote placeshifting device 120, media catcher 102 initially requests 302 the content from the placeshifting device 120, which in turn requests 304 the content from the media source 115 using, for example, an IR Blaster or other interface as appropriate (see signal 118 in FIG. 1). The remote media source 115 suitably responds by providing the desired content 306 to the placeshifting device 112, which in turn formats the content into a packet stream 308 that can be routed on network lo to media catcher 102.

If a viewer is watching a program on display 104 that is originating at content source 115, for example, and the viewer wishes to pause, rewind, choose a different program, and/or otherwise change the programming stream 308, the viewer simply depresses the appropriate button(s) on remote 107 to send a wireless message to media catcher 102.

Media catcher 102 receives and processes the command 310 as described above (e.g., using control logic 205 or the like) and then transmits a command message 312 to placeshifting device 112 via network 110. This command message 302 may be formatted, for example, in TCP/IP or UDP/IP format, and may have sufficient information contained within the message 302 to direct the remote placeshifting device 112 to generate the desired command on media source 115.

Command message 312 is received at placeshifting device 112, which then directs the media source 115 as appropriate. In various embodiments, placeshifting device provides a command 316 via an infrared, radio frequency or other interface, although equivalent embodiments could transfer command 316 over any sort of wired interface as well. Command 316 generates the desired response 318 from media source 115, which can then be relayed as a modified media stream, command message, and/or other suitable response 320 to media catcher 102.

In an equivalent embodiment, placeshifting is conducted from a computer system or server (e.g., computer 114) that is able to provide content 306 in response to a request 302 from media player 102. In such embodiments, media catcher 102 suitably forwards commands from remote control 107 to a software application (e.g., an application executing on computer system 114) to adjust a media player, screen capture or other feature as appropriate. That is, a software application executing on computer 114 or the like may act as the placeshifting device 120, and a media player, browser or other feature displayed on computer 114 may act as the media source 115. Other embodiments may operate in any other manner, or may eliminate such remote control functionality entirely. In embodiments that do provide the ability to transfer wireless remote instructions to a remote device over network 110, however, significant improvements to the user experience can be provided. That is, by allowing the user to transmit commands from a remote control 107 and receive results from a remotely-located media source, significant flexibility and convenience can be obtained.

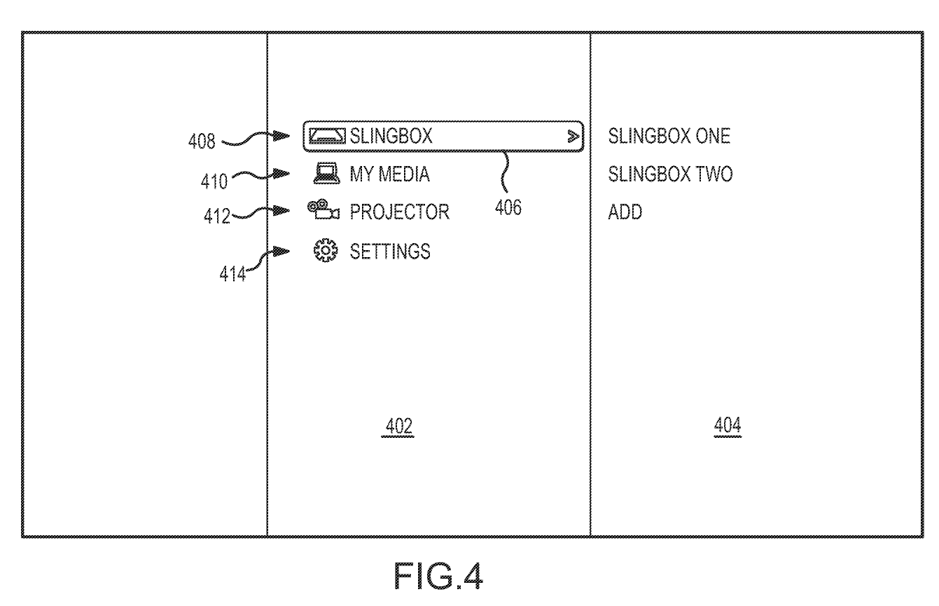

FIGS. 4-8 describe exemplary user interface images that could be used in some embodiments of a media catcher device 102, or in other devices as desired. As noted above, display processor 218 suitably generates interface screens or the like on display 104 in response to instructions from control logic 205. Users can interact with the interface screens by, for example, depressing keys on remote control 107 or the like. In various embodiments, remote control 107 includes directional input (e.g., directional keys, or a touchpad, directional pad, joystick, trackball and/or the like) that allows for movement in one or more dimensions. In a typical embodiment, movement in two or more dimensions is available to allow for movement in two orthogonal dimensions (e.g., up/down, left/right). Many embodiments also provide a “select” or “enter” key that allows for selection of items within a menu tree or other user interface feature. The exemplary interfaces shown in FIGS. 4-8 may be modified or supplemented in any manner. The appearance of the interfaces, for example, could be dramatically altered, as could the various menuing options and features presented. Further, while the exemplary embodiments of FIGS. 4-8 is described within the context of a media catcher 102, these concepts may be equivalently applied to any other type of device, including any sort of set top box, video recorder, video player or other device as desired.

FIG. 4 shows an exemplary interface that includes two or more columns 402, 404, with each column representing one level of a menu tree. Indicator 406 shows a highlighted feature in column 402. In the embodiment shown in FIG. 4, column 402 represents the currently selected menu, with column 404 presenting options that are available from the highlighted elements of column 402. As the user scrolls through the various menu selections available in column 402 by highlighting the various selections in column 402, column 404 displays the various sub-menu options available from the highlighted selection. This allows the user to very rapidly view the many options available in the sub-menu structure in column 404 without actually committing to any particular option in the parent menu shown in column 402.

The exemplary parent menu shown in column 402 of FIG. 4 includes four options corresponding to selecting a placeshifting device 112 (element 408), selecting media from a local storage device (element 410), selecting media from a computer 114 (element 412), and adjusting system settings for media catcher 102 (element 414). In this example, the user has highlighted, but not necessarily selected, the first option (element 408). Even before the user selects option 408, however, column 404 shows the available placeshifting devices 112 (identified as “Slingbox One” and “Slingbox Two” in this example), in addition to the option to add a new placeshifting device to the menu. If the user commits to option 408 (e.g., by depressing the “select” key on remote 107), then the contents of column 404 would typically be moved to column 402, and any sub-menus below the highlighted “SlingBox One”, “SlingBox Two” or “Add” features would become visible in column 404. Alternatively, the columns may be shifted only when the selected element has further layers of sub-menus so that the parent menu remains visible in column 402 when the bottom of the menu tree has been reached.

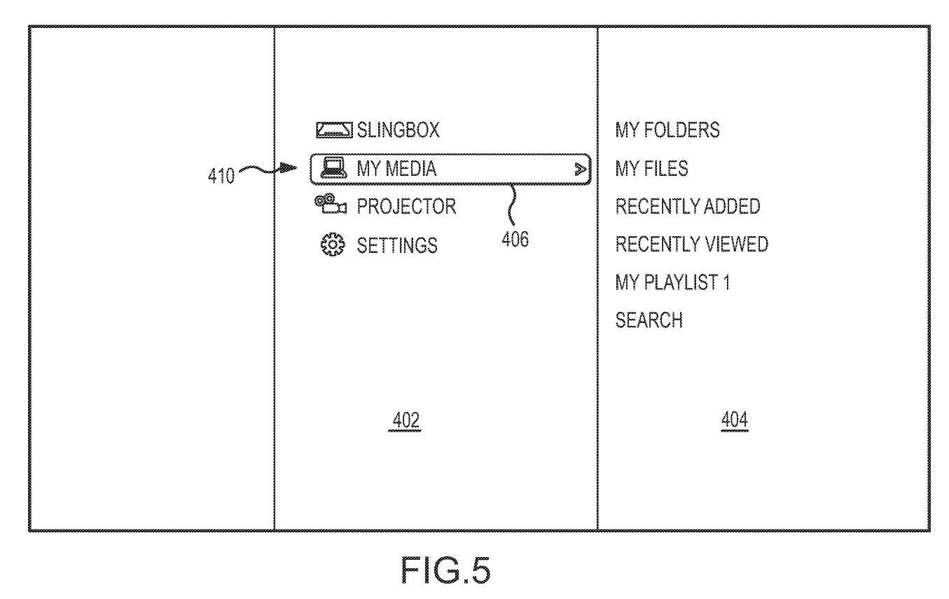

As noted above, the contents of one or more sub-menus can be displayed (e.g., in window 404) without necessarily selecting an option in column 402. In FIG. 4, for example, the viewer may be able to scroll upwardly or downwardly in column 402 to view the various sub-menu features available from the various options 408-414. If the viewer scrolls the indicator 406 downwardly from option 408 to option 410, for example, an exemplary display such as that shown in FIG. 5 may be presented. FIG. 5 shows an exemplary list of options in column 404 (e.g., “My Folders”, “My Files”, “Recently Added”, “Recently Viewed”, playlists, search, etc.) that could be associated with files stored on a media 106. While other embodiments may provide additional or other options for each feature in menu 402, the ability to rapidly view sub-options 404 available for each feature allows the viewer to rapidly identify and select a particular feature.

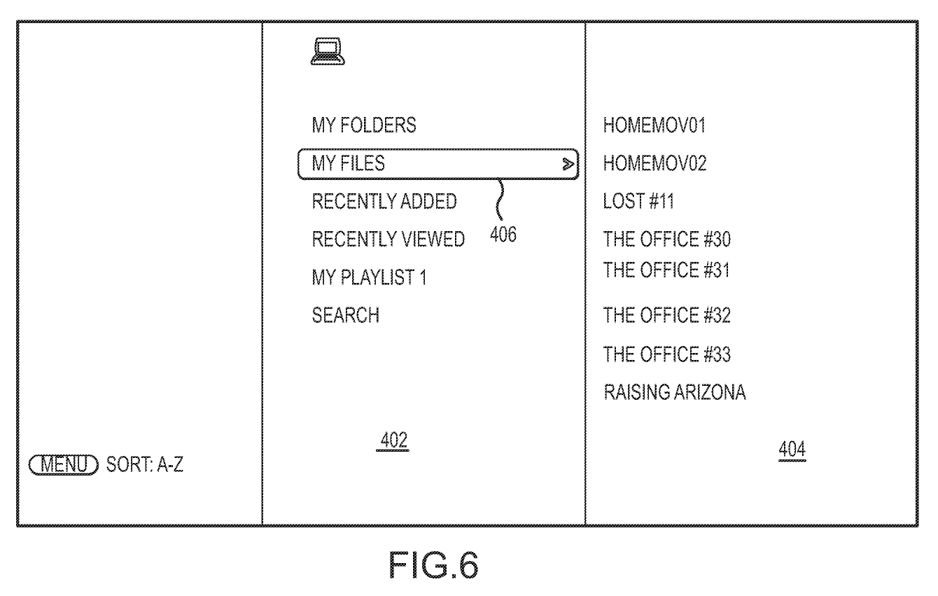

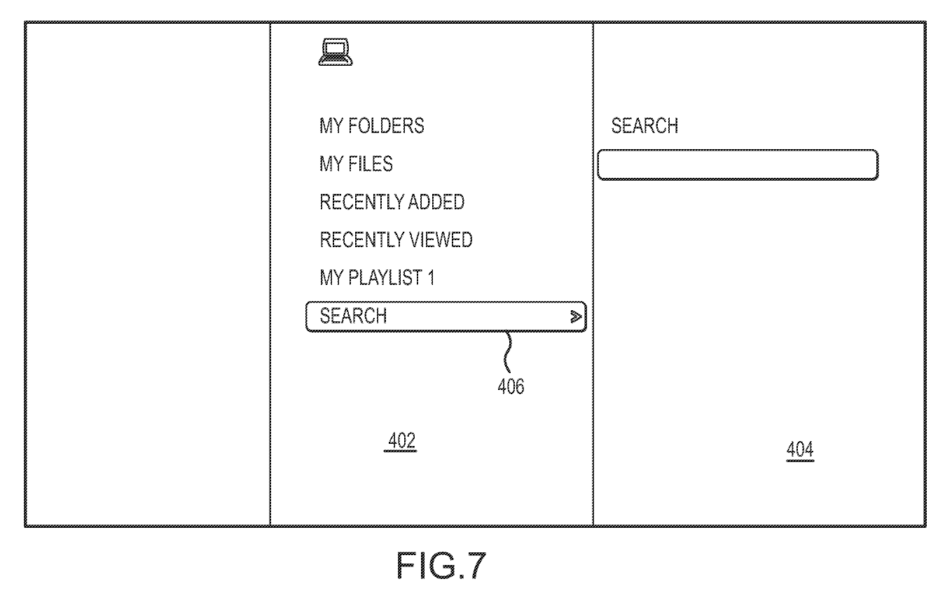

FIG. 6 shows an interface that could result from the viewer selecting the “My Media” feature 410 that was shown in column 402 of FIGS. 4-5. In the exemplary embodiment of FIG. 6, the selection of feature 410 resulted in the contents of column 404 being shifted into column 402 so that these features can be navigated using indicator 406. As described above, the various submenus available from each feature shown in column 402 can be presented in column 404 without necessarily selecting the feature in column 402. FIG. 6, for example, shows a listing of files that can be accessed (e.g., from media 106) under the “My Files” option in column 402. FIG. 7 similarly shows an exemplary interface that could result from scrolling to the “Search” option in column 402, thereby generating a view of a search window or other feature in column 404.

As noted above, scrolling may be conducted in any manner (e.g., in response to directional inputs (e.g., depresses of arrow or other directional keys) received at remote control 107, with selection of any feature occurring in response to the activation of a select key, or any other feature as desired. In some embodiments, vertical movements (e.g., vertical button presses or vertical movements on a touchpad, joystick, directional pad or other input device) could be correlated to scrolling upwardly or downwardly within a particular column 402, and horizontal movements of the same or similar features being correlated to selection inputs, or other movement between columns 402 and 404.

Various other modifications and enhancements could be provided as well. The contents of columns 402 and 404 may be differently shaded, colored or otherwise emphasized, for example, so that the selectable menu element is readily identifiable to the viewer or to otherwise provide selective focus. Similarly, the selector box or feature could be implemented in any manner, such as with a rectangular box and/or by changing the appearance of the highlighted menu, as shown in the various figures.

One advantage of the dual-column menu structure, coupled with menu previewing as described above, is that the viewer is able to very quickly find the contents of the various sub-menus. This is particularly helpful in the context of a media catcher 102 that receives media content from various sources. That is, if a user is looking for a particular program, image, video clip and/or the like, the user can manually search the menu tree very quickly without committing to particular menu options. Moreover, great convenience to the user is facilitated by providing a common menu/interface structure for content located on multiple media sources.

Not only does the common structure allow for ease of use, but in various embodiments, searching for content available across multiple sources can be facilitated. In such embodiments, media catcher 102 suitably maintains a list of files available from the various media sources 115 that can be navigated and/or searched as desired.

In general, text-based searching on set-top devices has been inconvenient because full keyboards are generally not available for such devices, and because on-screen keyboards have traditionally been inconvenient and/or non-intuitive to use. Moreover, many on-screen keyboards are necessarily relatively large relative to the size of the display screen, thereby obscuring much of the information displayed on the screen. To remedy these issues, a compact and easy-to-use text entry technique would be desired.

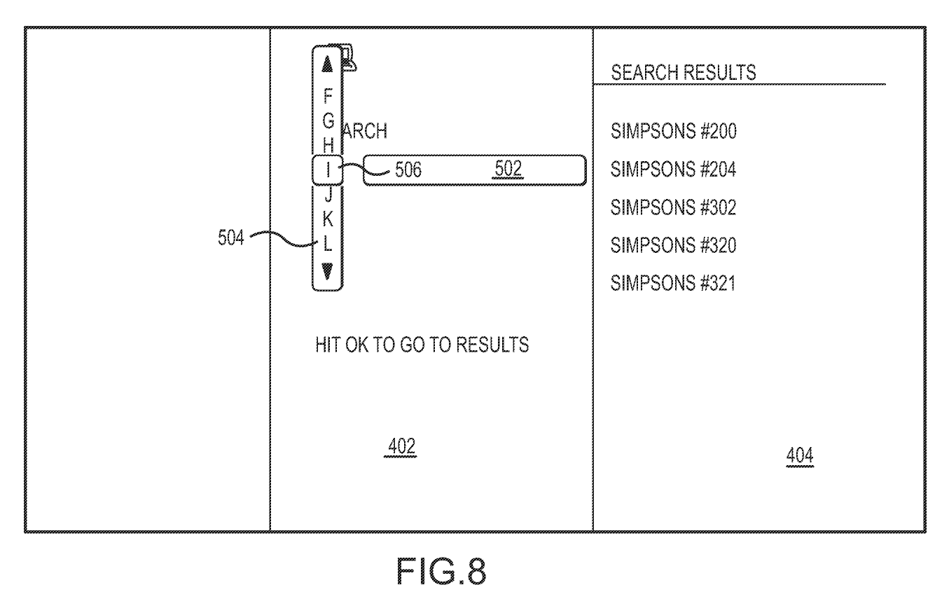

FIG. 8 shows one text-entry technique that may be used on media catcher devices and other devices as appropriate. As shown in FIG. 8, a one-dimensional scrollbar 504 has a highlight portion 506 that indicates a character that can be selected. FIG. 8 shows a vertical implementation of the scrollbar 504; in such embodiments, the user scrolls upwardly or downwardly until the desired letter appears in the highlighted portion 506. In an alternate embodiment, a horizontal scrollbar 504 could be provided and the user would scroll left or right until the desired letter appeared in portion 506; other geometric arrangements or layouts may be contemplated in various equivalent embodiments.

Scrolling in vertical or horizontal directions may be provided in response to any sort of directional input. Inputs received from a touchpad, scrollbar, rocker switch, directional pad, joystick, trackball or other input could be readily correlated to a direction and/or magnitude of scrolling. Discrete or continuous button presses (e.g., presses of an arrow or other directional indicator button) may be similarly used to create the scrolling effect within scrollbar 504. After scrolling to the desired letter for text entry, the user then selects the desired letter by depressing a “select” or “enter” key on remote 107, as appropriate. The selected character may appear in a text entry field 502, and additional character entry may occur, as desired by the user.

In various embodiments, search results are shown in the adjoining column as the user enters text. The search results may be focused or narrowed as additional characters are entered in some embodiments. Column 404, for example, could present files or other features with titles or other characteristics that match the textual data that is already entered by the user. If the user enters the letters “S” and “I”, for example, column 404 could show any available content that begins with the letters “SI”, as shown in the exemplary embodiment of FIG. 8. In other embodiments, no searching is conducted until the user indicates that text entry is complete.

This basic structure may be supplemented, modified and/or enhanced in any manner. The size of scrollbar 504 may be enlarged or reduced, for example, to show any number of characters (including a single character) and/or to accommodate spatial restrictions on the display.

The scrolling text entry technique has a number of advantages that can be realized in various embodiments. It is readily scalable to multiple character sets, including foreign language sets, for example. If a user selects a foreign language in the “settings” menu, for example, the text entry structure can readily accommodate any additional characters used in the foreign language character set. Further, character sets can be limited to operating contexts. That is, the full alphanumeric set (including, for example, both upper and lower case letters) may not be needed in all instances. Using the techniques described above, unneeded characters can be readily excluded when and where it is appropriate to do so.

In still further embodiments, the basic keyboard input structure can be supplemented by using key inputs from the remote control 107 or the like. For example, users could use a numeric keypad to rapidly skip to particular letters. By associating certain number keys with certain letters (e.g., as seen on many conventional telephones used for text messaging), those letters can be rapidly accessed by simply depressing the number key one or more times if the user does not want to scroll through the entire character set. Other streamlining features could be added in other embodiments.

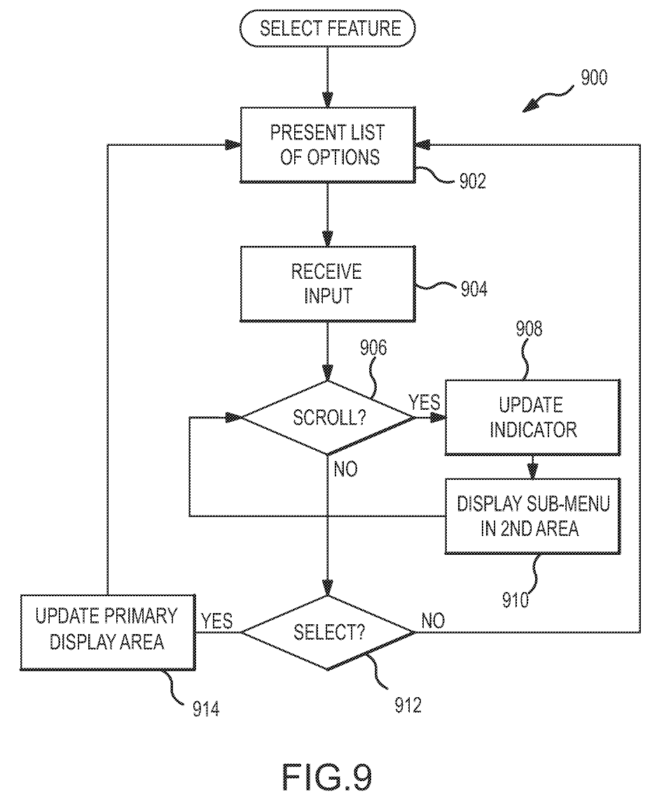

FIG. 9 is an exemplary process 900 that may be used to select a particular feature of a user interface. In some embodiments the particular feature selected may be selection or playback of a media file or program, although other embodiments may provide any other features as appropriate. Process 900 may be implemented in any manner; in various embodiments, each of the steps shown in process 900 may be carried out by hardware, software and/or firmware logic residing within a media catcher device 102 or the like. Controller module 205 (FIG. 2), for example, may contain software or firmware logic that is able to be stored in memory, mass storage or any other medium and that is executable on any processor (e.g., the SoC processor described above) to carry out the various steps and other features shown in FIG. 9.

Process 900 as shown in FIG. 9 suitably includes the broad steps of presenting a list of multiple options in a first area of the interface (step 902), receiving an input from the user (step 904), processing the input to scroll (steps 906, 908) the indicator in the first area of the interface and to update the sub-menu displayed in a second area of the interface (step 910), and processing a selection input (step 912) to update the first area of the interface with the sub-menu options associated with the selected option (step 914). Many practical embodiments may modify and/or supplement the exemplary process shown in FIG. 9 in any manner. The various processing steps may be combined in to common software or firmware modules, for example, and/or the particular logic shown in FIG. 9 may be logically, temporally and/or spatially re-arranged in any manner.

Process 900 suitably begins by displaying a list of options in a first portion of the user interface. FIG. 4, for example, shows a list of various options that are presented within column 402 and that are indicated with indicator 406. Other embodiments may present the first and second areas of the interface in any other manner. The various areas may be re-shaped, re-sized, presented in any spatial layout, and/or otherwise modified as desired. Moreover, it is not necessary that the options presented within the first area of the interface be displayed in a vertical scrolling arrangement; alternate embodiments may provide any sort of horizontal, rotary and/or other arrangement as desired.

Inputs are received as appropriate (step 904). In various embodiments, user inputs are received via remote control 107 or any other device via any sort of input interface (e.g., RF interface 207 in FIG. 2). As noted above, inputs may be directional, alphanumeric or any other types of inputs as desired.

Different types of inputs may be processed in any manner. Scrolling inputs, for example, may be identified (step 906) and processed to update a position of an indicator 406 (step 908) and to display the appropriate sub-menu information in the second area of the interface (step 910). In the embodiment shown in FIG. 4, for example, vertical inputs received from remote control 107 are identified and used to update the position of indicator 406 with respect to the various options presented in column 402. If indicator 406 is initially positioned on the “Slingbox” option shown in FIG. 4, for example, a downward input may move indicator 406 to the “My media” option, as shown in FIG. 5. Additionally, the information presented in the second portion of the interface (e.g., in column 404) may be updated (step 910) based upon the scrolling input to present the sub-menu information associated with the option that is indicated in column 402. As noted above, this sub-menu information may be displayed without the user selecting the particular option in column 404. That is, as the user scrolls within the first area (e.g., column 402), the information in column 404 can be automatically updated without waiting for a “select” input from the user.

When a “select” input is received from the user (step 912), the first and second areas of the interface may be updated in any appropriate manner (step 914). As one example, a user selection of the “My media” option in FIG. 5 could result in the sub-menu information displayed in the second area (e.g., column 404) being subsequently presented in the primary area (e.g., column 402) as shown in FIG. 6. Selection may take place in any manner, such as through the activation of a “select” button on remote 107, a directional input that is orthogonal to the primary scrolling direction (e.g., a horizontal directional input in the example of FIGS. 4-6), or the like.

By allowing the user to view sub-menu information prior to selection of a particular feature, rapid inspection and traversal of the menu tree can be achieved. This can have significant benefit in a wide variety of applications. In the context of a media catcher device 102, for example, a relatively large menu tree that may include a large number of file names, media titles and/or other information which may be obtained from a multitude of disjoint sources can be rapidly traversed to allow the user to quickly find and select a desired option. Moreover, the search features described above with respect to FIG. 8 can be readily incorporated into the menu structure, thereby further increasing the power and flexibility of the interface. Such features may be widely adopted across any type of media catcher, media player, file storage, and/or other devices as desired.

As used herein, the word “exemplary” means “serving as an example, instance, or illustration.” Any implementation described herein as exemplary is not necessarily to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method of presenting information on a display in response to a user input received from an input device, the method comprising:
presenting a first plurality of options in a first portion of a user interface on the display;
receiving a first user input indicating one of the first plurality of options;
in response to the first user input, presenting a sub-menu of options in a second portion of the user interface, wherein the sub-menu of options is associated with the indicated one of the first plurality of options;
receiving a second user input selecting an indicated one of the sub-menu of options; and
in response to a second user input, presenting the sub-menu of options in the first portion of the user interface.

2. The method of claim 1 wherein the presenting of the sub-menu of options in the second portion of the user interface occurs prior to receiving the second user input.

3. The method of claim 1 wherein the presenting of the sub-menu of options occurs automatically in response to the user indicating, but not selecting, the indicated one of the first plurality of options in the first portion of the user interface.

4. The method of claim 1 wherein the first user input corresponds to a scrolling input.

5. The method of claim 1 wherein the first and second portions of the user interface are adjacent columns, and wherein the first user input corresponds to scrolling in a vertical direction.

6. The method of claim 5 further comprising adjusting the position of an indicator in the first portion of the user interface in response to the scrolling input.

7. The method of claim 1 wherein the first plurality of options corresponds to a list of sources of media content, and wherein the first user input comprises a selection of one of the sources of media content.

8. The method of claim 7 wherein the list of sources of media content comprises both a local storage device and a remote placeshifting device that is accessible over a network.

9. The method of claim 8 wherein the sub-menu associated with the local storage device comprises a listing of media files stored on the local storage device.

10. The method of claim 9 further comprising playing a selected one of the media files stored on the local storage device.

11. The method of claim 9 further comprising:
presenting a search window as part of the user interface;
displaying a single-character scroll window associated with the search window;
receiving a third user input that indicates a character in the single-character scroll-window; and
displaying the indicated character in the search window.

12. The method of claim 11 further comprising selecting a plurality of the media files associated with the indicated character.

13. The method of claim 11 wherein the third user input comprises an alphanumeric input.

14. A system for presenting imagery on a display in response to user inputs received from an input device, the device comprising:
a first interface configured to receive the user inputs from the input device;
a second interface to the display; and
a processor coupled to each of the first and second interfaces and configured to generate user interface imagery on the external display via the display interface, wherein the user interface imagery comprises a first column configured to present a plurality of options and a second column configured to automatically present one of a plurality of sub-menus associated with an identified one of the plurality of options presented in the first column, and wherein the processor is further configured to present the sub-menu associated with the identified one of the plurality of options in the first column in response to a user selection of the identified one of the plurality of options.

15. The system of claim 14 wherein the first interface is a wireless interface to a remote control.

16. The system of claim 15 wherein the system further comprises a third interface to a storage device and a fourth interface to a network.

17. The system of claim 16 wherein the plurality of options corresponds to a list of sources of media content, the list of sources comprising the storage device and a placeshifting device accessible via the network.

18. The system of claim 17 wherein the sub-menu associated with the storage device comprises a listing of media files stored on the storage device.

19. The system of claim 18 wherein the processor is further configured to present a search window as part of the user interface imagery, to display a single-character scroll window associated with the search window, to receive a user input that indicates a character in the single-character scroll-window, and to display the indicated character in the search window.

20. A device for providing media content from a storage device for presentation on an display, the device comprising:
a first interface to a wireless input device;
a second interface to the storage device;
a third interface to the display; and
a processor configured to select media content from the storage device based upon user inputs received from the first interface in response to user interface imagery presented on the display via the third interface, wherein the user interface imagery comprises a first column configured to present a plurality of options and a second column configured to automatically present one of a plurality of sub-menus associated with an identified one of the plurality of options presented in the first column, and wherein the processor is further configured to present the sub-menu associated with the identified one of the plurality of options in the first column in response to a user selection of the identified one of the plurality of options.
